(19) United States
(12) Patent Application Publication
(10) Pub. No.: US 2011/0162466 A1
(43) Pub. Date: Jul. 7, 2011

(54) POWER TAKE-OFF

(75) Inventors: Harold G. Hillyer, (US); Roland Cabrera, (US)

(73) Assignee: Hydreco, Charlotte, NC (US)

(21) Appl. No.: 12/900,188

(22) Filed: Oct. 7, 2010

Related U.S. Application Data
(60) Provisional application No. 61/249,306, filed on Oct. 7, 2009.

(51) Int. Cl. F16H 37/00

(52) U.S. Cl. 74/11

(57) ABSTRACT

A power take-off (PTO) includes new features to make it more environmentally friendly, improve service life, and reduce service part inventory. The idler shaft, which holds the pick-up gear for connecting the PTO to a transmission, may include a splined shaft. The pick-up gear and an idler gear may be mounted on the splined in different configurations. The output of the PTO, including a splined output and an output plate for connecting to secondary equipment such as a hydraulic pump, can be easily replaced or reconfigured to work with different configurations of secondary equipment.

### CROSS-REFERENCE TO RELATED APPLICATIONS

This application claims priority under 35 U.S.C. §119(e) to provisional U.S. Patent Application No. 61/249,306, filed Oct. 7, 2009, the disclosure of which is expressly incorporated by reference herein in its entirety.

### BACKGROUND

1. Field of the Present Disclosure

The present disclosure is directed to a power take-off (PTO) that may be attached to a mechanical transmission, such as that found in the powertrain of trucks, tractors, and other large equipment. A PTO built in accordance with the present disclosure may be more environmentally friendly, experience less wear and failure, have lower inventory requirements, and other advantages.

2. Related Art

A power take-off (PTO) is a device that transmits mechanical power from a vehicle's engine to an item of secondary equipment that is separate from the vehicle's powertrain. A PTO commonly takes the form of a male or female splined driveshaft. PTOs are commonly found on farm tractors, where they are used to power equipment such as a disc harrow, plow, broadcast seeder, or the like.

Commercial and industrial vehicles commonly have a transmission that can accept a separate power take-off, which may to be referred to as a semi-permanent PTO. Rather than directly powering secondary equipment, a PTO on a commercial or industrial vehicle is typically used to drive a hydraulic pump. A hydraulic fluid system is then used to transmit the mechanical power to other locations on the vehicle, where a hydraulic motor powers any secondary equipment. Example applications include raising or lowering the bed of a dump truck, running a water pump on a fire truck, raising the bucket on a cherry picker, and so on.

PTOs currently in use and on the market may be prone to leaking lubricants and other fluids. Leaks may be the result of units' age, but it may also be a design flaw. Such leaks may be harmful to the environment, but many industries that use PTOs are facing pressures to “go green” and act more environmentally responsible. Such responsibility may go beyond reducing or eliminating leaks and spills and may include extending the service life of units, thereby decreasing overall waste. Moreover, units with longer service lives and lower maintenance requirements are also less expensive to operate.

Additionally, PTOs are used on numerous different types, makes, and models of vehicles, and accordingly PTOs must be designed and built to fit each. This results in the need to manufacture and stock a large inventory of PTOs for each application, as well as a large inventory of parts to service each of the different PTOs.

Accordingly, there is a need for an improved power take-off that is less likely to leak oil or other fluids into the environment and that may also have a longer service life or require less maintenance.

### SUMMARY

The present disclosure meets the foregoing need and enables PTOs to have a reduced inventory and environmental impact, which results in a significant decrease in parts storage, improved service life, and other advantages apparent from the discussion herein.

Accordingly, one aspect of the present disclosure is directed to a system for transferring power from a mechanical transmission to secondary equipment. The system includes a housing for connecting to a mechanical transmission and a splined shaft inside the housing. A pick-up gear transfers power from the transmission to the splined shaft. The pick-up gear can be mounted on the splined shaft in two or more different positions, and the gear can be removed from the shaft. The system further includes an idler gear, which can also be mounted on the splined shaft in two or more positions and can be removed from the splined shaft. An output gear, which is mounted on an output shaft, can engage the idler gear. When engaged, the output gear rotates the output shaft. A splined output is mechanically connected to the output shaft. The system also includes an output plate, which can be connected to and disconnected from the housing, for connecting to secondary equipment.

The system may also include an idler shaft inside the housing and connected to the housing at both ends. The splined shaft may spin or rotate about the idler shaft. The idler shaft may have a pair of O-rings at each end to substantially prevent leakage of liquids from inside the housing. The system may include one or more O-rings that substantially seal one or more external surfaces of the housing. The O-rings may include one or more blisters that act to hold the O-ring in place during assembly or service of the system. The output plate may include a telltale or monitor hole. The system may include an output adaptor configured to mate with, or fit inside of, the splined output and provide a different output configuration. The housing may include one or more blind mounting holes. The system may include a grease nipple that provides lubricant to the splined output, a plug to cover the grease nipple, and an O-ring to seal the plug over the grease nipple. By sealing the plug, the O-ring may prevent any substantial leakage of lubricant from the grease nipple. The system may include a fork to mount or move the output gear and a floating piston to move the fork between two or more positions. In the first position, the output gear is engaged with the idler gear, and in the second position, the output gear is disengaged from the idler gear.

The system may include a thrust washer that transfers thrust from the pick-up gear to a thrust bearing. The thrust washer may include one or slots for promoting lubrication of one or more bearings. The system may also include a push-in air fitting. The system may further include an additional bearing configured to align the splined output with a shaft from the secondary equipment.

According to another aspect of the present disclosure, a power take-off (PTO) includes a housing for connecting to a transmission and a splined shaft located inside the housing. The PTO also includes a pick-up gear for transferring power from the transmission to the splined shaft. The pick-up gear is mounted on the splined shaft and may be removed from the shaft. In addition, the pick-up gear can be mounted on the shaft in two or more positions. An idler gear also mounts on the splined shaft. The idler gear is also removable and can be mounted in two or more different positions. The PTO also includes an output gear on an output shaft. The output gear can engage and disengaged the idler gear. When engaged with the idler gear, the output gear rotates the output shaft. A splined output is mechanically connected to the output shaft. The PTO also includes an output plate that connects to the housing and can be removed. The output plate surrounds the splined output and connects to secondary equipment.

The PTO may also include an idler shaft located inside the housing. The splined shaft may rotate or spin about the idler shaft. The idler shaft may be connected to the housing at both ends. In addition, both ends of the idler shaft may be sealed by a pair of O-rings that substantially prevent leakage of liquids from inside the housing. The PTO may also include one or more O-rings for substantially sealing one or more external surfaces of the housing. Each O-ring may have one or more blisters to hold the O-ring in place during assembly or service of the PTO.

The PTO may further include a grease nipple for providing lubricant to the splined output and a plug for covering the grease nipple. The plug may include an O-ring to seal the plug over the grease nipple and prevent any substantial leakage of lubricant from the grease nipple. The PTO may include an output adaptor that mates with, or fits within, the splined output and provides a different output configuration. The PTO may include an additional bearing for aligning the splined output with a shaft from the secondary equipment.

Additional features, advantages, and embodiments of the present disclosure may be set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

### BRIEF DESCRIPTION OF THE DRAWINGS

The accompanying drawings, which are included to provide a further understanding of the present disclosure, are incorporated in and constitute a part of this specification, illustrate embodiments of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1 shows a housing or casting of a power take-off (PTO) according to the present disclosure;

FIG. 2 shows a PTO housing with the outline of a large output gear superimposed;

FIG. 3 shows blind mounting holes;

FIG. 4 shows an assembled PTO according to the present disclosure;

FIG. 5 shows an air shift unit;

FIG. 6 shows a detail of an air shift unit;

FIG. 7 shows a detail of an O-ring;

FIG. 8 shows a serrated flanged nut;

FIG. 9 shows a cutaway of a grease nipple and plug;

FIG. 10 shows an assembled PTO with a different output plate;

FIG. 11 shows a detail view of an output adaptor;

FIG. 12 shows a telltale hole;

FIG. 13 shows a detail view of a telltale hole;

FIG. 14 shows a detail view of an idler shaft of a PTO;

FIG. 15 shows a cutaway view of a PTO;

FIG. 16 shows an alternate cutaway view;

FIG. 17 shows a thrust washer according to the present disclosure;

FIG. 18 shows a pick-up gear;

FIG. 19 shows an idler gear mounted on a splined shaft;

FIG. 20 shows an idler gear and a pick-up gear mounted on a splined shaft;

FIG. 21 shows a cutaway of an air shift unit; and

FIG. 22 shows a detail view of an air fitting.

### DETAILED DESCRIPTION

The embodiments of the present disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the present disclosure. The examples used herein are intended merely to facilitate an understanding of ways in which the present disclosure may be practiced and to further enable those of skill in the art to practice the embodiments of the present disclosure. Accordingly, the examples and embodiments herein should not be construed as limiting the scope of the present disclosure, which is defined solely by the appended claims and applicable law. Moreover, it is noted that like reference numerals represent similar parts throughout the several views of the drawings.

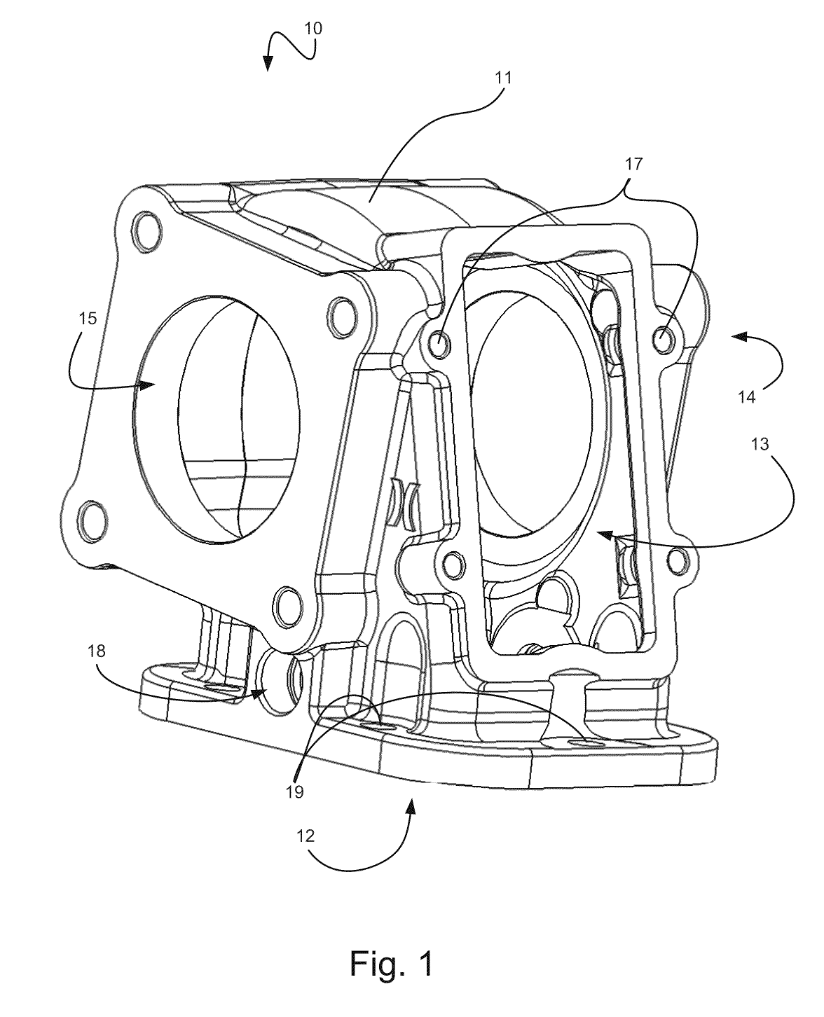

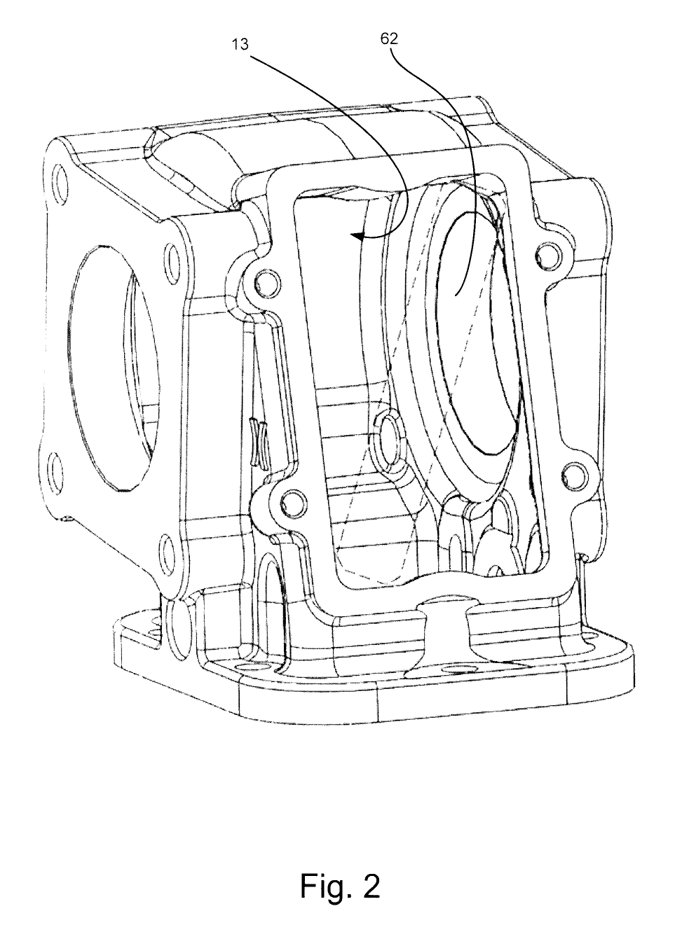

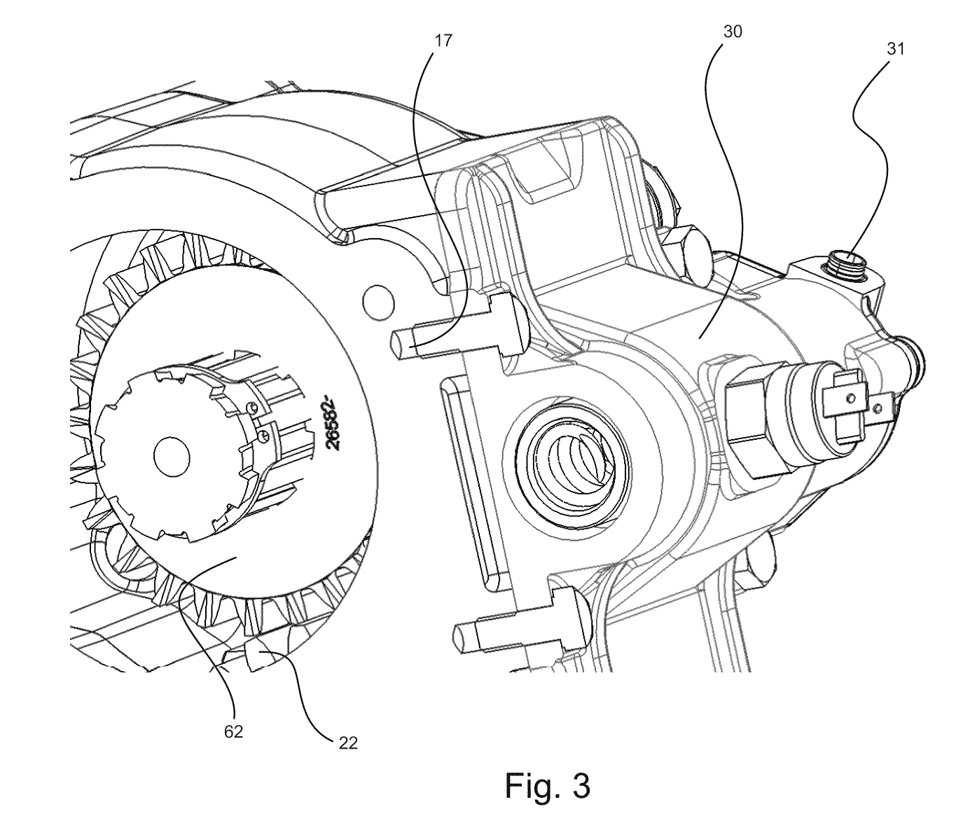

FIG. 1 shows a housing or casting of a power take-off (PTO) according to the present disclosure, FIG. 2 shows a PTO housing with the outline of a large output gear superimposed, and FIG. 3 shows blind mounting holes. In particular, as shown in FIG. 1, a power take-off (PTO) 10 may include a housing 11 with four openings or apertures: bottom opening 12, air shift opening 13, rear opening 14, and front opening 15. The large air shift opening may be sized and configured to accommodate installation of a large output gear 62, as shown in FIG. 2. Mounting holes 17 may be placed around the edges of air shift opening 13, rear opening 14, and front opening 15 for mounting equipment or covers to the openings. Mounting holes 17 may be “blind” holes, i.e. not connected to the central chamber of the housing, as shown in FIG. 3. The use of blind holes may reduce or eliminate the possibility of oil, lubricant, or other substances leaking from the PTO through the mounting holes 17 and thus reduce or eliminate contaminating or damaging the environment. This arrangement may also reduce or eliminate the potential of contaminants entering PTO 10. The housing 11 may also have a hole 18 for a gear shaft (not shown in FIG. 1), as well as mounting holes 19 for attaching the PTO 10 to a transmission or similar power source (not shown). PTOs may have six or eight mounting holes 19, although any number of mounting holes 19 may be used with the present disclosure without departing from its spirit or scope.

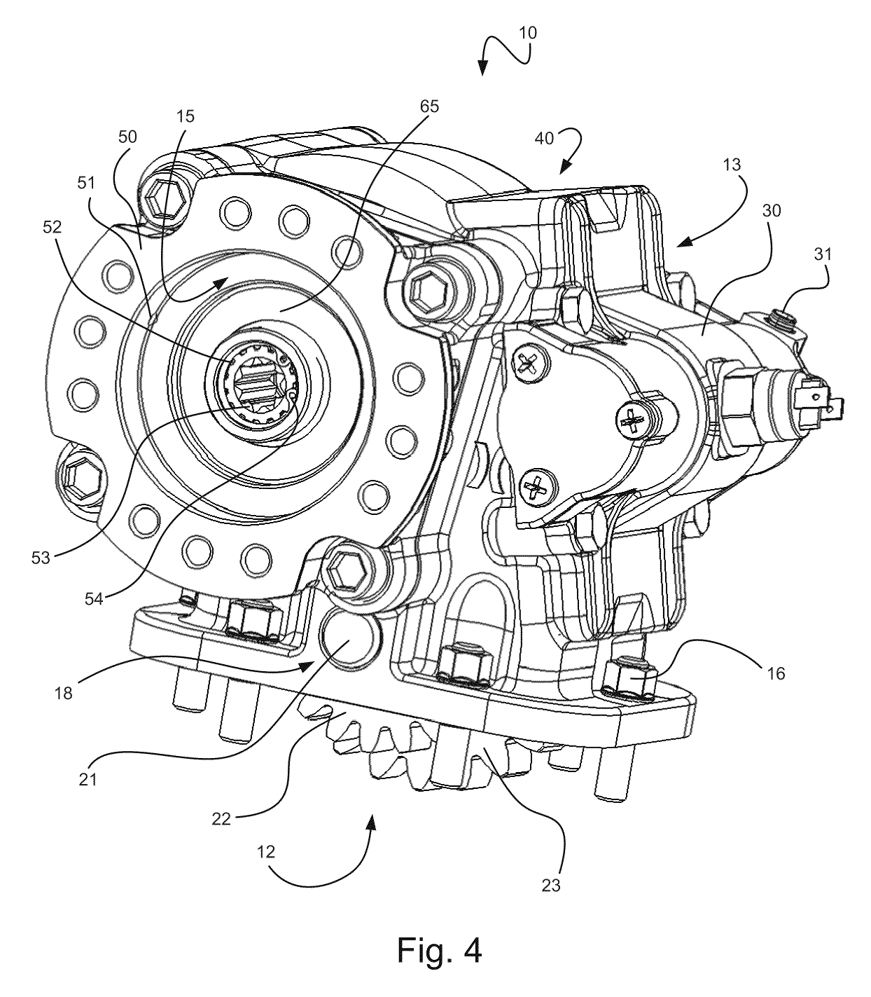

FIG. 4 shows an assembled PTO 10 constructed according to the present disclosure. The internal mechanisms are discussed in detail below; the present discussion is limited to externally visible features. In particular, an air shift unit 30 may be attached to air shift opening 13 and may include an air fitting 31. An output plate 50, which may include a telltale hole 51, may be attached to front opening 15. At the center of the output plate 50 may be bearing 65 and splined output 52. Splined output 52 may be fitted with an output adaptor 53 that alters the diameter and size and/or number of splines in the output. The output adaptor 53 allows a single PTO to power equipment with driveshafts of differing sizes or spline arrangements without having to replace the entire output shaft. This may reduce parts inventory and make servicing and installation of the PTO 10 easier. Output adaptor 53 may be held in place with a circlip 54. An idler shaft 21 may be located in hole 18, and an idler gear 22 and pick-up gear 23 may protrude through the bottom opening 12. Flanged nuts 16 may be used to securely attach the PTO 10 to a transmission (not shown).

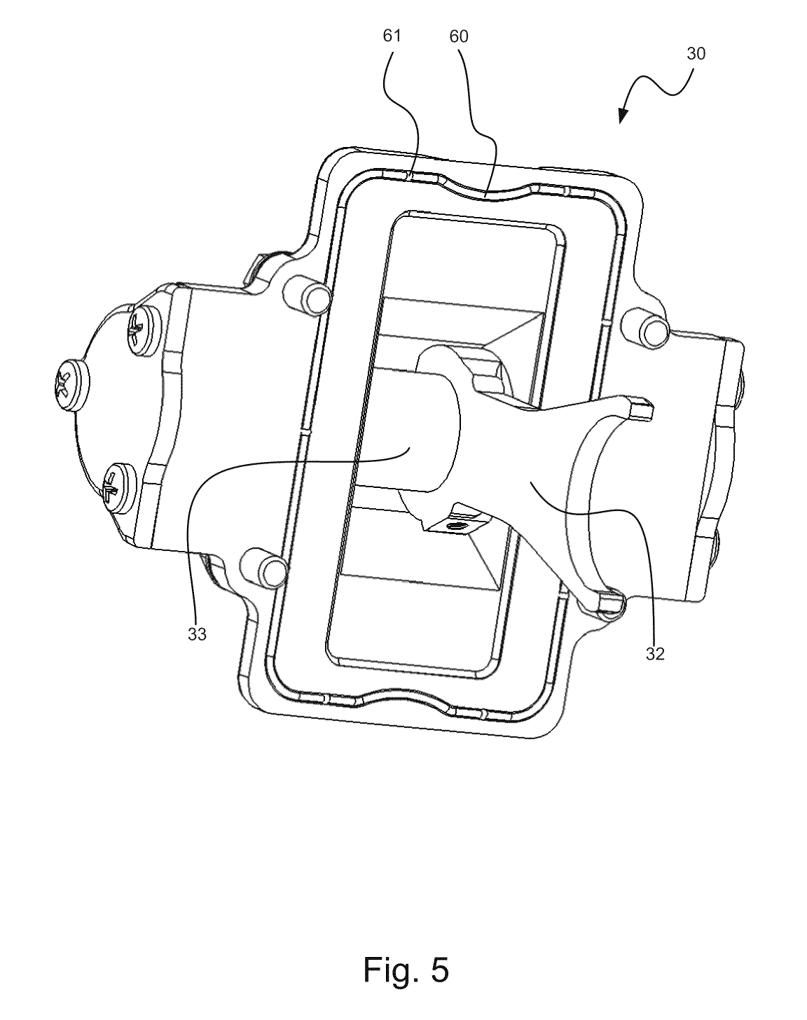

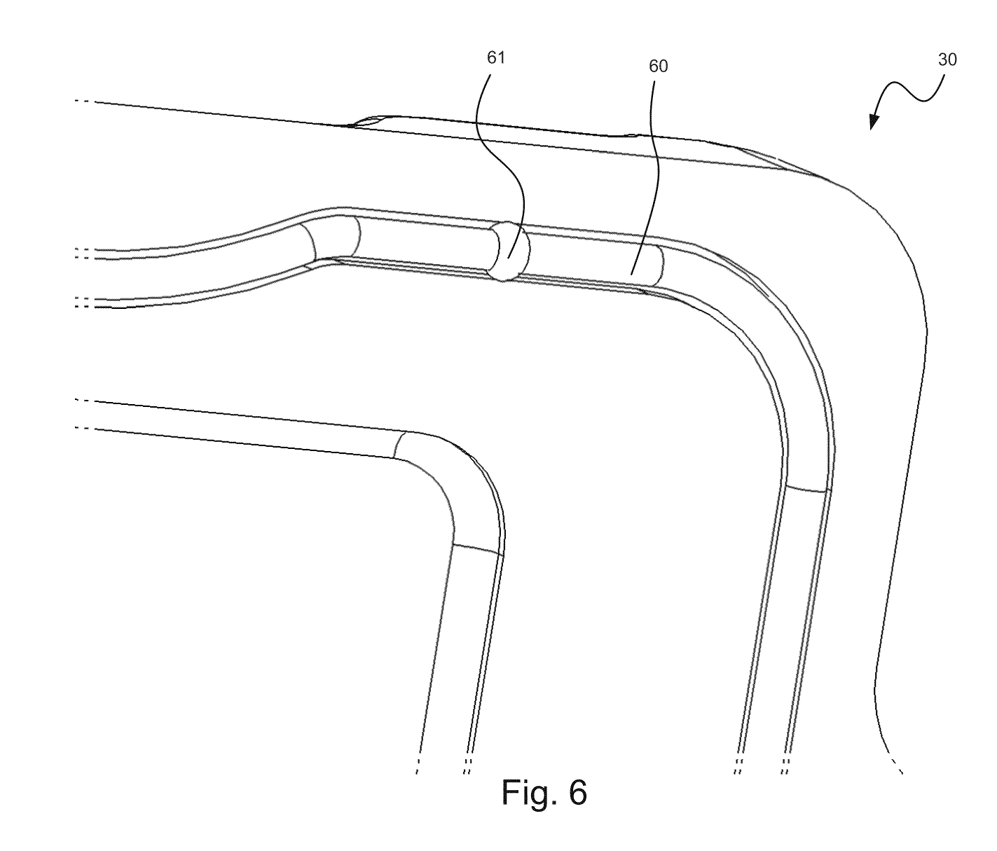

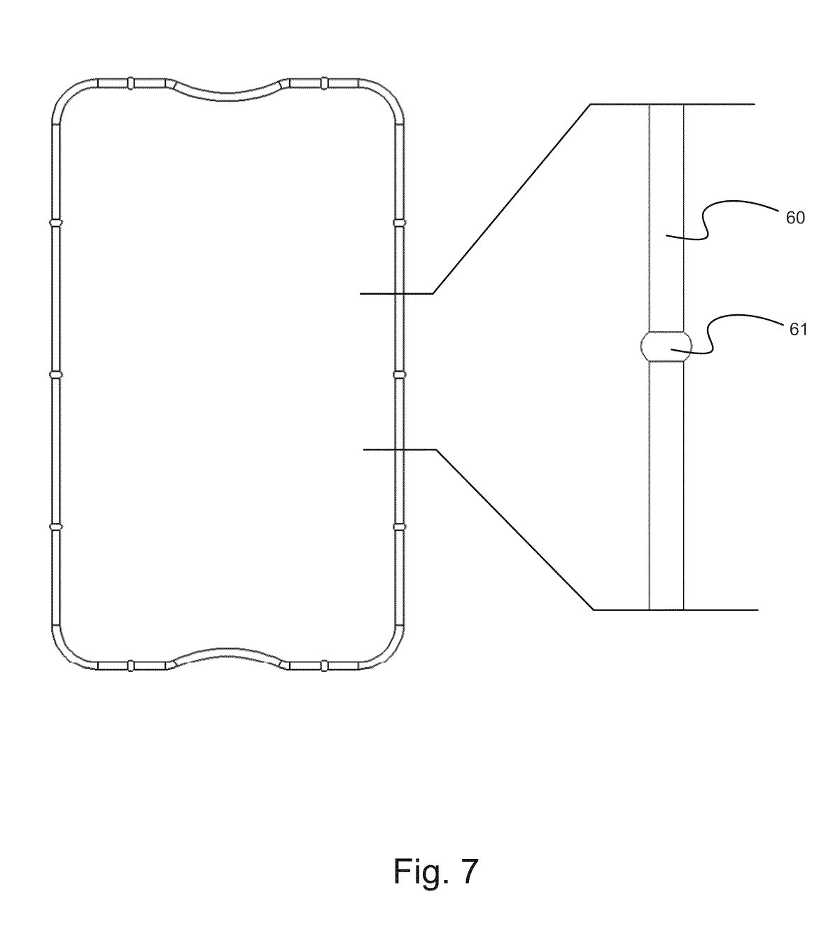

FIG. 5 shows an air shift unit, FIG. 6 shows a detail of an air shift unit, and FIG. 7 shows a detail of an 0-ring. In particular, the underside of air shift unit 30 is visible in FIG. 5. The unit may include a fork 32; which may itself mount an output gear 62. Fork 32 may be mounted on piston 33, which may shift the fork 32 back and forth, engaging and disengaging an output gear 62 with idler gear 22. The connection between air shift unit 30 and housing 11 may be sealed using an O-ring 60 instead of a conventional gasket. O-rings may be better able to resist damage due to heat and other factors, thereby giving a better seal for a longer period of time than a conventional gasket. O-rings may be formed from a fluoroelastomer, such as Viton® from DuPont Performance Elastomers. Shown in detail in FIGS. 6 and 7, the O-ring 60 may include one or more blisters 61 that may keep the O-ring in position during assembly and service. The larger cross-section of the blister 61 may help retain the O-ring in its groove when parts are assembled or disassembled.

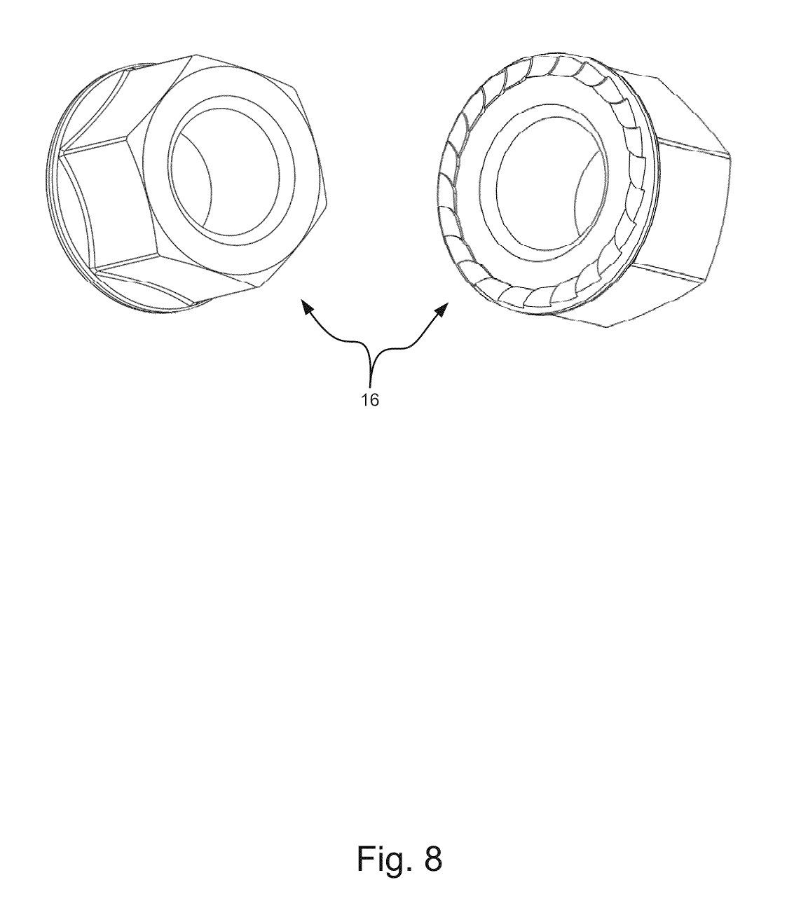

FIG. 8 shows a serrated flanged nut. In particular, flanged nut 16, shown in FIG. 8, may have a narrow width for improved spanner clearance. The back of the nut 16 may be serrated, to reduce the likelihood of the nut 16 loosening during operation. Other types of fastener modification to reduce the likelihood of loosening are also contemplated.

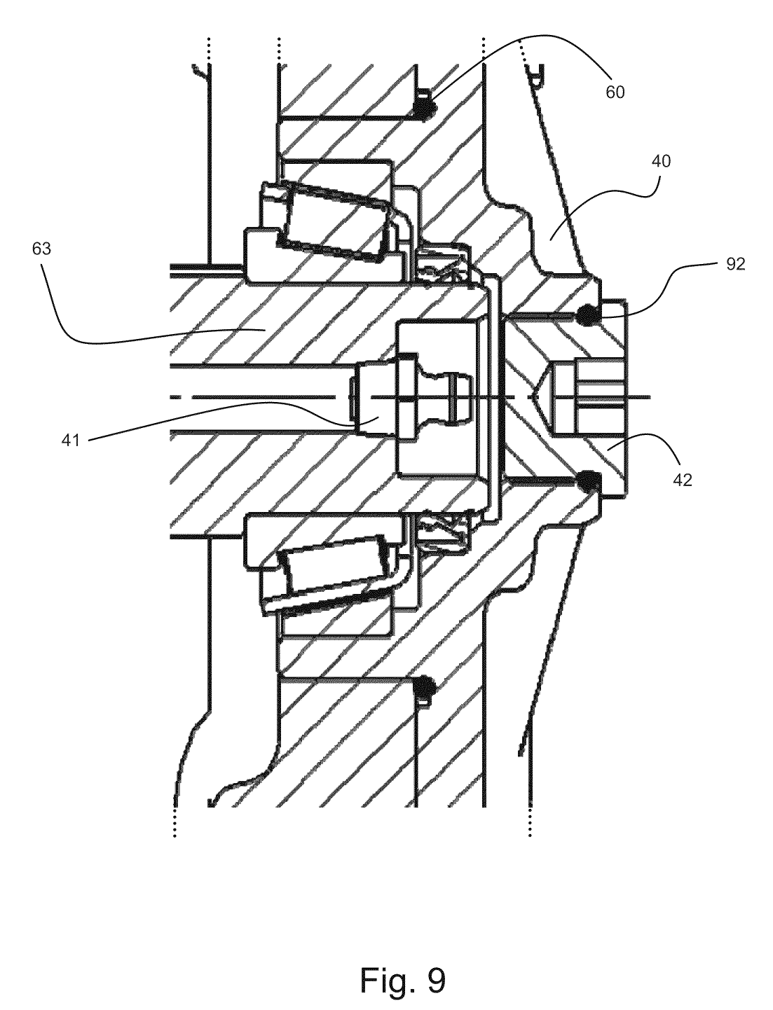

FIG. 9 shows a cutaway of a grease nipple and plug. In particular, FIG. 9 shows a cut-away partial view of the rear cover 40, which covers rear opening 14. As with air shift unit 30, rear cover 40 may be sealed with an O-ring instead of the typical gasket. A grease nipple 41 may be located in output shaft 63. This configuration may permit lubrication of splined output 52 without needing to disconnect PTO 10 from any attached secondary equipment. Grease nipple 41 may have an internal seal, and the seal may be removed. Removal of the seal allows splined output 52 to operate as a wet spline, which may promote longer life of both the PTO 10 and a shaft (not shown) connecting splined output 52 to the attached secondary equipment. Grease nipple 41 may be covered or protected by a plug 42. Plug 42 may itself be sealed with an O-ring 92, which may reduce or prevent leakage of grease or lubricant. The use of plug 42 and O-ring 92 may make the PTO 10 more environmentally friendly.

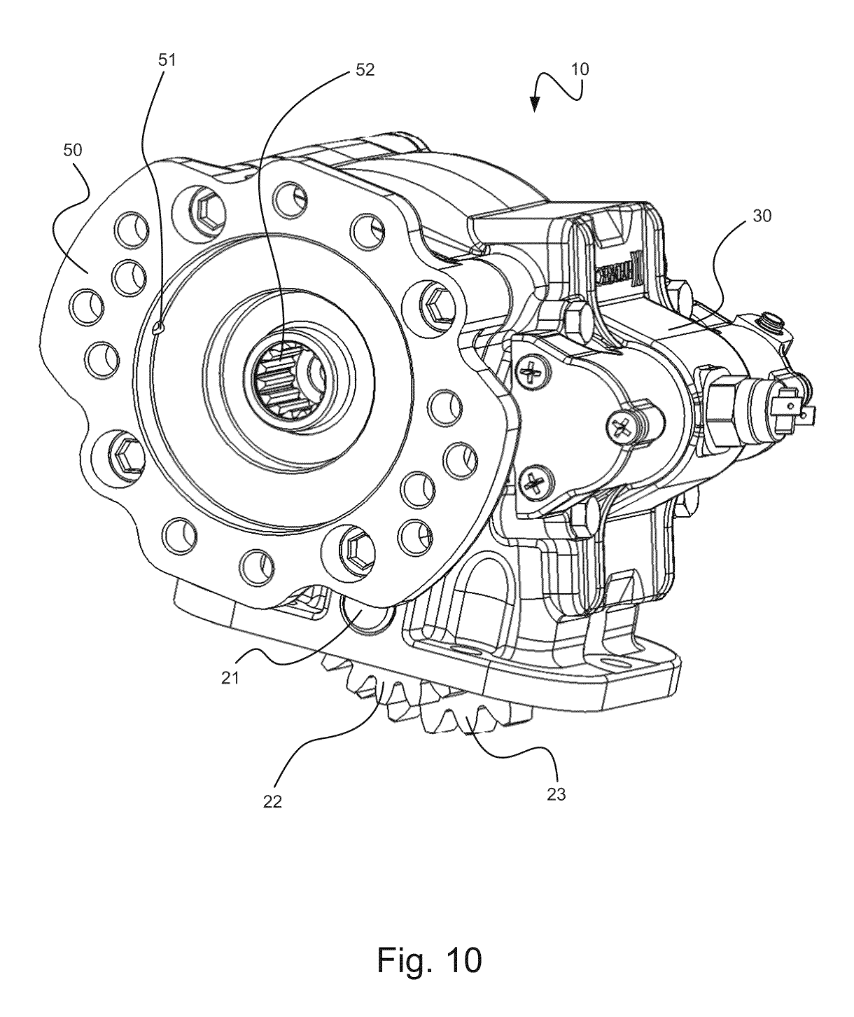

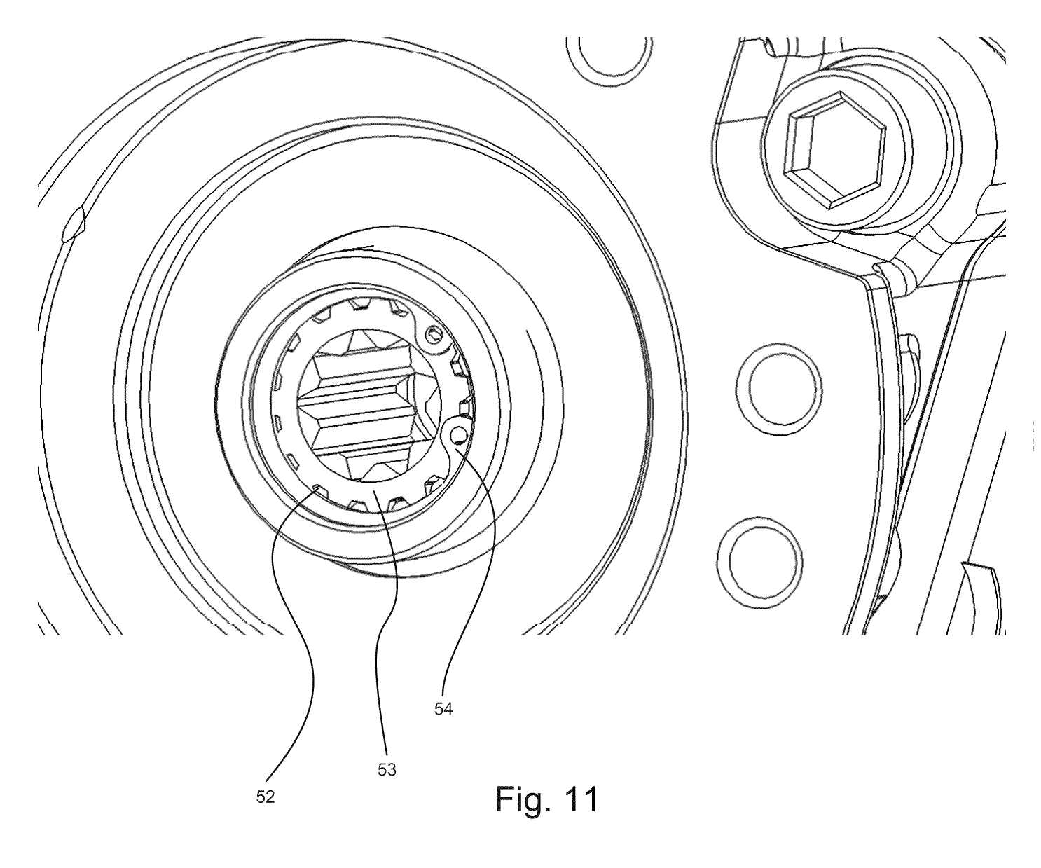

FIG. 10 shows an assembled PTO with a different output plate. In particular, FIG. 10 presents essentially the same view of PTO 10 as FIG. 4. Air shift unit 30 is visible on the right side of the unit, and idler shaft 21, idler gear 22, and pick-up gear 23 are visible at the bottom. The PTO 10 shown in FIG. 10, however, is fitted with a different output plate 50 than the PTO seen in FIG. 4. The FIG. 10 PTO is also missing output adaptor 53 and circlip 54, which may be seen in detail in FIG. 11. The different output plate 50 and missing output adaptor 53 allow the PTO of FIG. 10 to interface with different secondary equipment than its FIG. 4 counterpart.

Furthermore, one configuration may be changed to the other with a minimum of servicing. Prior art designs include an output plate that cannot be replaced or swapped for a different configuration. Similarly, changing the size of the splined output requires at least swapping the entire output shaft. Changing or replacing the output shaft is labor (and therefore cost) intensive and exposes the internals of the PTO to the environment, potentially increasing stress and wear due to additional contaminants and the like.

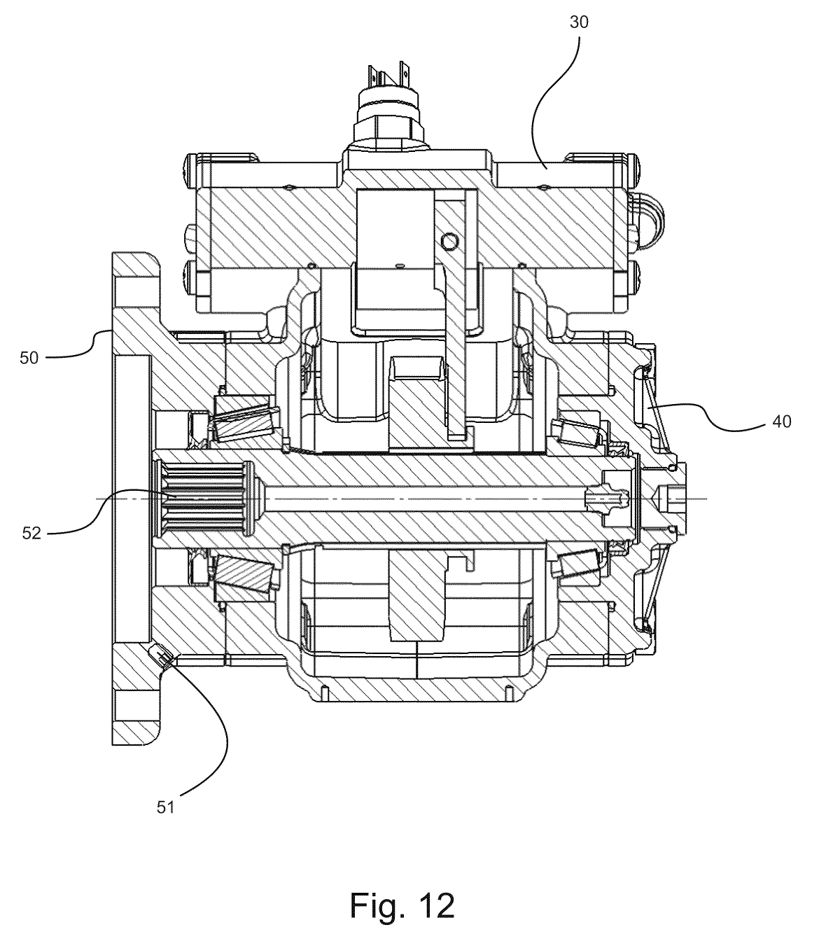

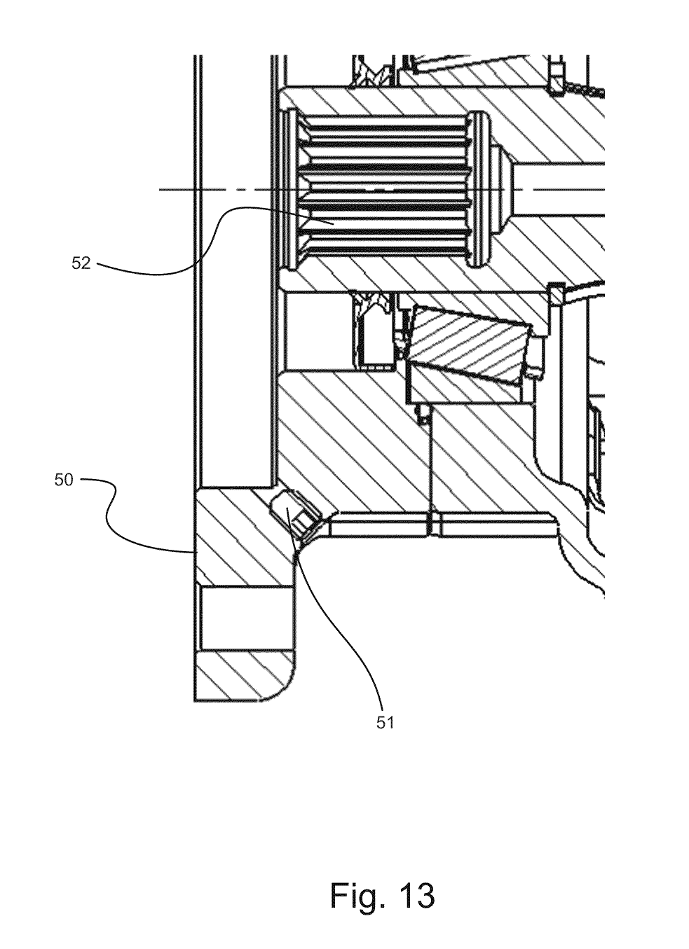

FIG. 12 shows a telltale hole, and FIG. 13 shows a detail view of a telltale hole. In particular, output plate 50 may include a telltale hole 51, as shown in FIG. 12 with an enlarged partial view in FIG. 13. Telltale hole 51 may be used, for example, to check for leaks or the collection of lubricant in the space between the PTO 10 and secondary equipment. Such checks may be performed prior to servicing the PTO 10. If a leak is detected, the service person may then take appropriate steps to ensure that there is no environmental contamination during servicing. Telltale hole 51 may be plugged, which may prevent dirt or water mixing with lubricant. A plug may also prevent leakage of oil or other fluids from the unit. More than one plug 51 may be implemented and may be used in different locations.

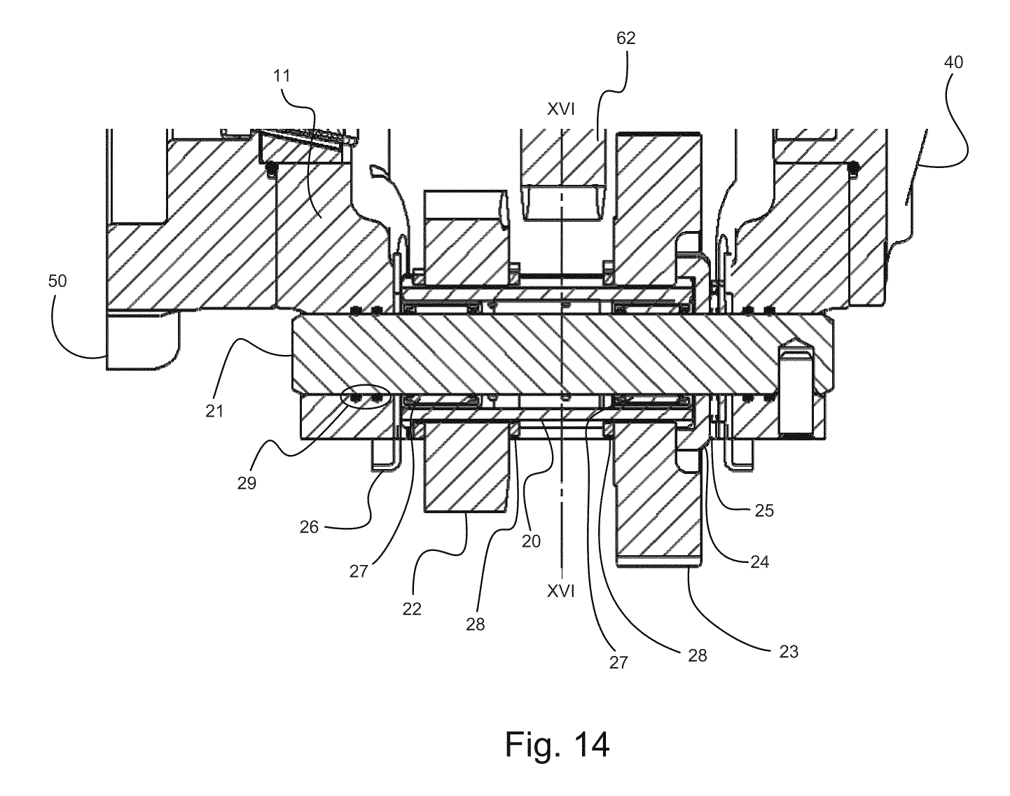

FIG. 14 shows a detail view of an idler shaft of a PTO. In particular, FIG. 14 shows a cutaway view of idler shaft 21 and associated mechanisms. Splined shaft 20 rotates or spins about idler shaft 21 on bearings 27. Bearings 27 may, for example, be roller bearings, needle bearings, ball bearings, or the like. Idler gear 22 and pick-up gear 23 may be removably mounted on splined shaft 20 and may be held in place with one or more circlips 28. Pick-up gear 23 may have an indentation 182 designed to receive a thrust washer 24, which transfers thrust from pick-up gear 23 to thrust bearing 25. Thrust washer 24 may have one or more slots or holes 174 to enable positive lubrication of bearings 27 of splined shaft 20 as described below. Stationary washers 26 may protect housing 11 from stress and wear that might normally occur due to direct contacts between the housing 11 and splined shaft 20.

Idler shaft 21 may be sealed at either end by double O-rings 29. By using two or more O-rings on each side, the present disclosure may substantially reduce or virtually eliminate leakage of lubricants and other substances from hole 18. This arrangement may also reduce or eliminate such leakage, which may be a source of environmental contamination and pollution.

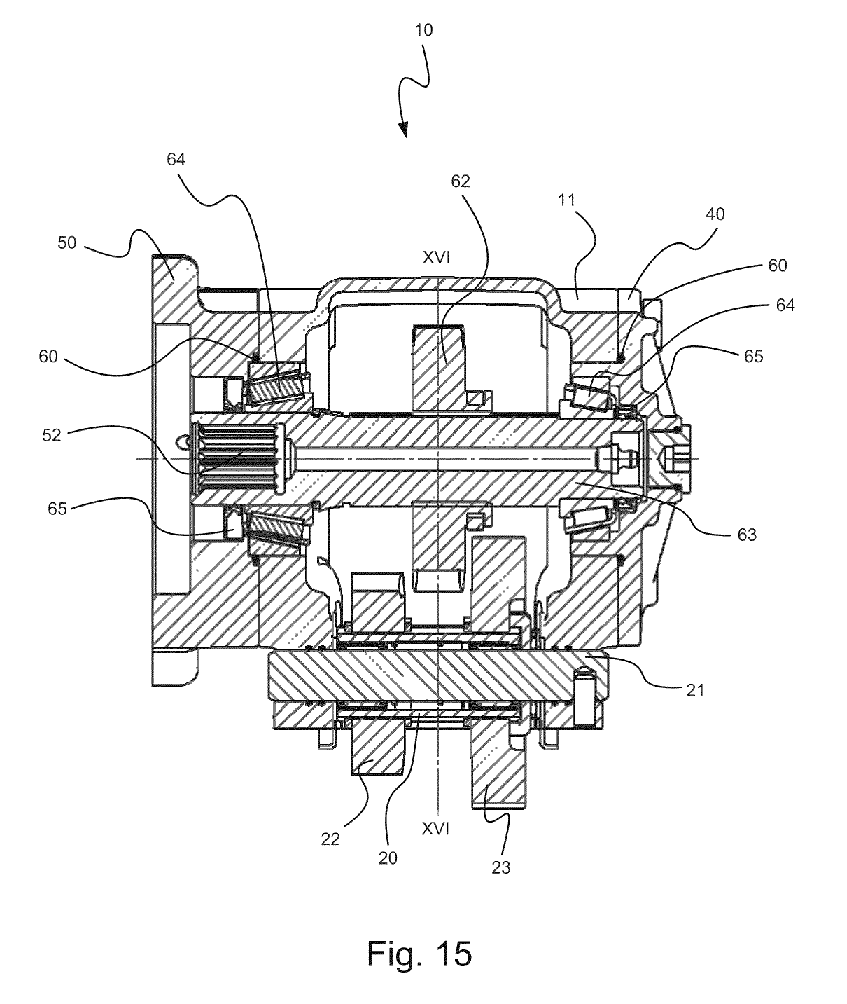

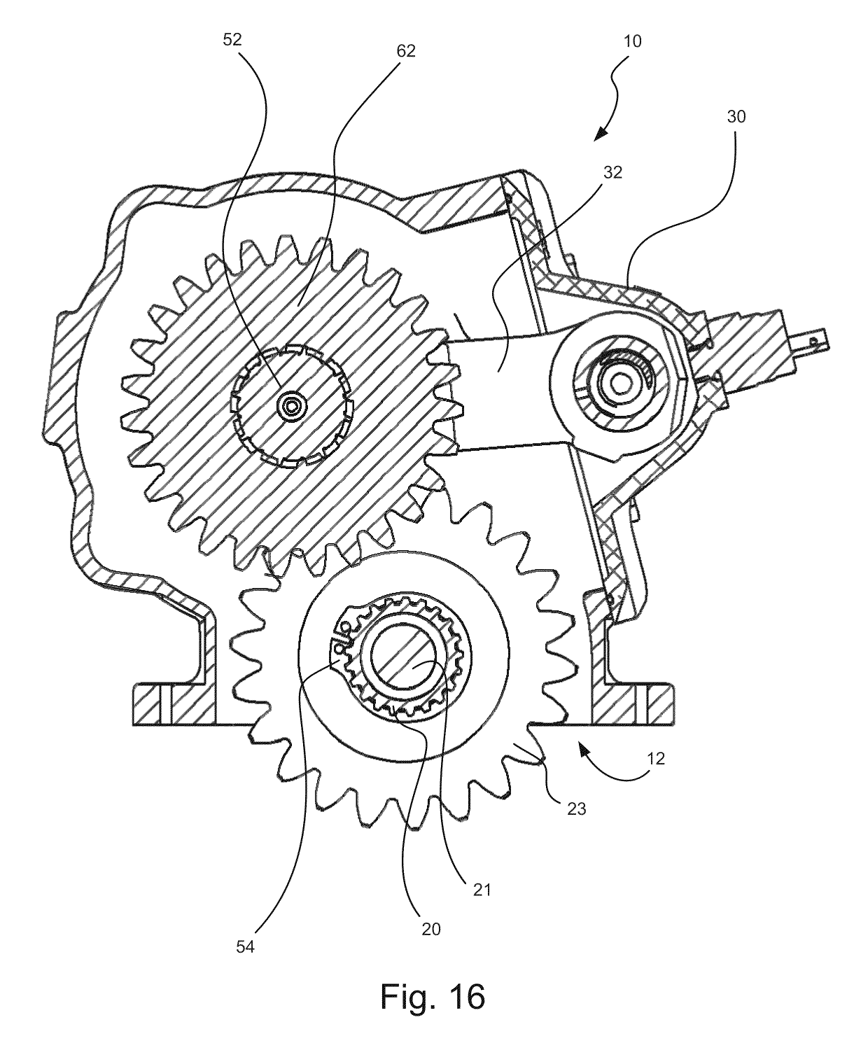

FIG. 15 shows a cutaway view of a PTO, and FIG. 16 shows an alternate cutaway view. In particular, FIG. 15 shows a cutaway of PTO 10 taken.along the axis of output shaft 63 and idler shaft 21, while FIG. 16 shows a cutaway taken perpendicular to shafts 63 and 21 along line XVI. The use of splined shaft 20 and circlips 54 allows multiple configurations of gears 22 and 23 on shaft 20. For example, in the configuration shown in FIG. 15, pick-up gear 23 may be positioned at the rear of splined shaft 20, idler gear 22 may be positioned at the front of splined shaft 20, and the center may be clear. Output gear 62 may be positioned over the middle of shaft 20 when the PTO 10 is not active. To activate the PTO, air shift unit 30 may cause output gear 62 to move and engage idler gear 22.

Assuming the vehicle's transmission is engaged, pick-up gear 23 will receive power from the transmission. The pick-up gear 23 turns splined shaft 20, which turns idler gear 22. When output gear 62 engages idler gear 22, it spins, and in so doing, spins output shaft 63. Output shaft 63 may be mechanically linked to splined output 52 such that rotation of output shaft 63 results in rotation of splined output 52. As shown in FIG. 15, splined output 52 may be embedded in output shaft 63, although other linkages, such as gears, chains, and the like, may be used without departing from the spirit and scope of the present disclosure.

Output shaft 63 may be held in place by bearings 64. Bearings 64 may be any appropriate type of bearing, including, e.g., tapered roller bearings, roller bearings, needle bearings, ball bearings, or the like. Output shaft 63 may also be associated with additional bearings 65. Additional bearing 65 may be used to align splined output 52, instead of using the spigot from the output, as is conventionally done.

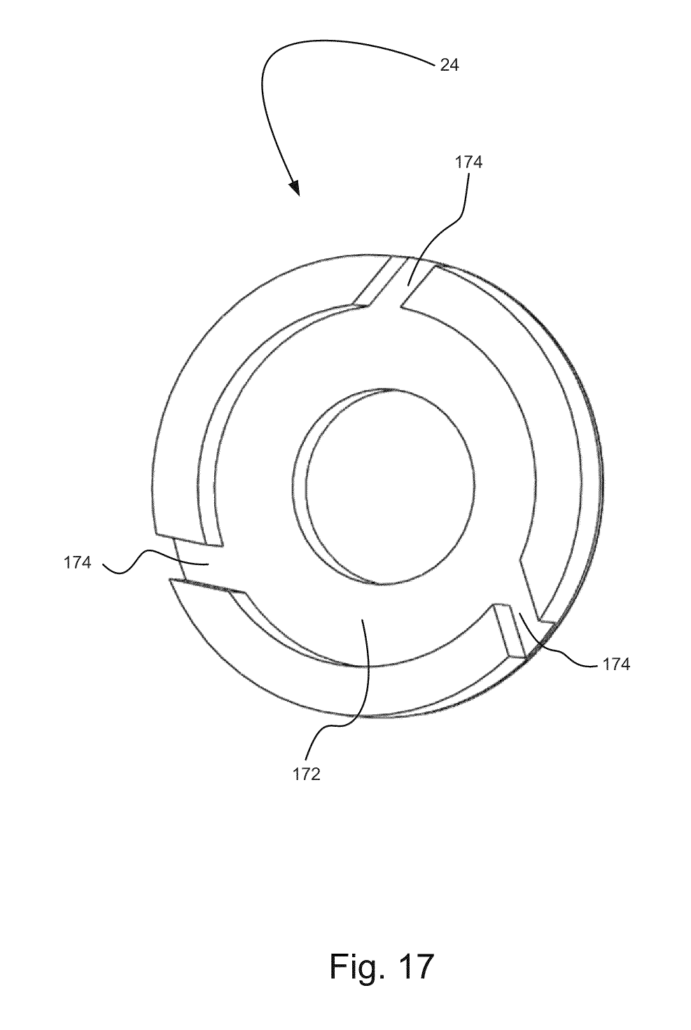

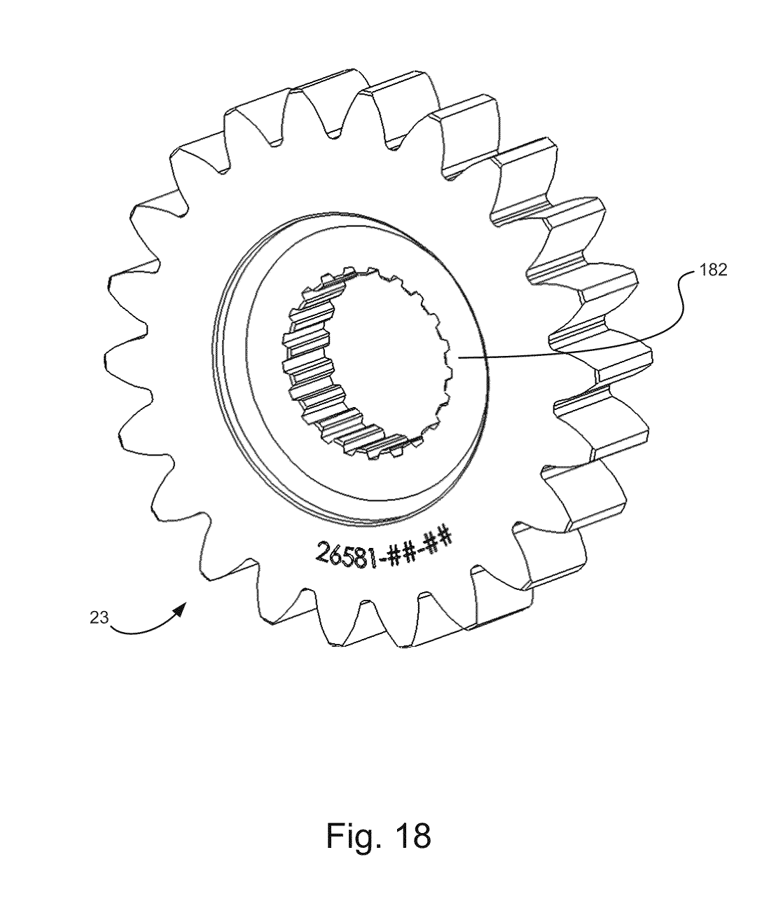

FIG. 17 shows a thrust washer according to the present disclosure, and FIG. 18 shows a pick-up gear. In particular, FIG. 17 shows a perspective view of thrust washer 24. The concave upper surface 172 shown fits into the indentation 182 on pick-up gear 23 seen in FIG. 18. FIG. 17 shows holes or channels 174 in thrust washer 24 that permit lubrication of bearings 27 within splined shaft 20. Additional configurations of the holes are possible without departing from the spirit and scope of the present disclosure.

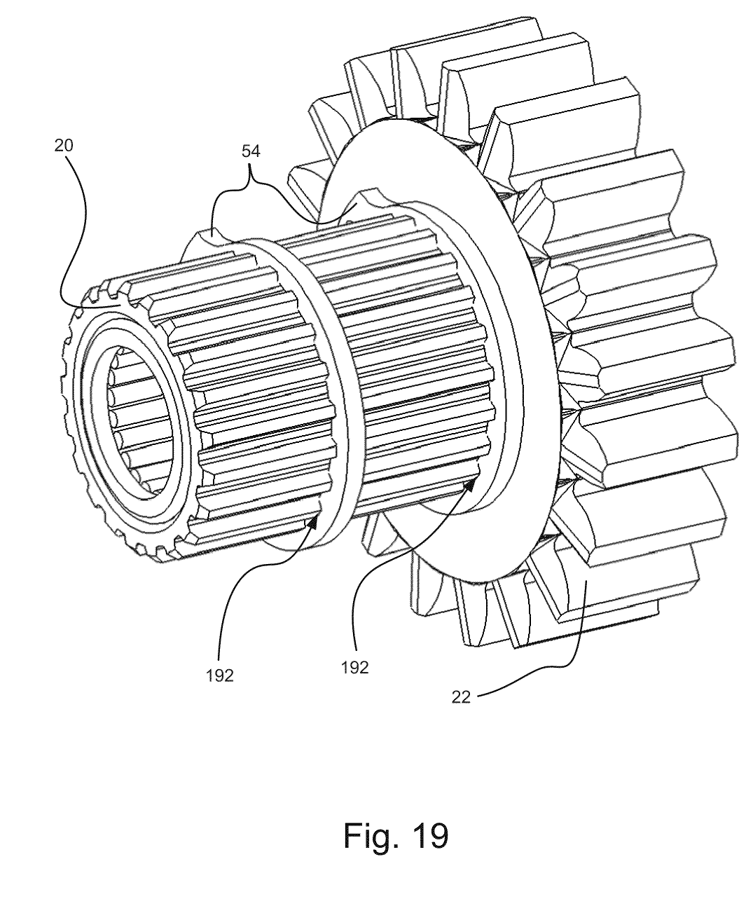

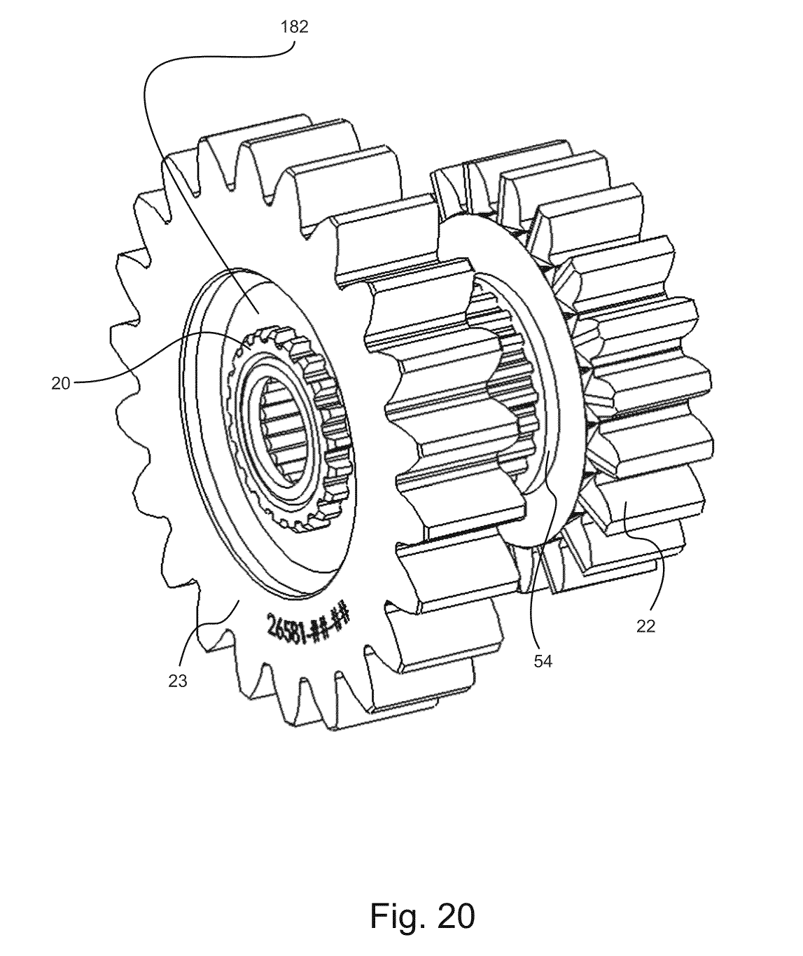

FIG. 19 shows an idler gear mounted on a splined shaft, and FIG. 20 shows an idler gear and a pick-up gear mounted on a splined shaft. In particular, FIG. 19 shows splined shaft 20 with idler gear 22 and circlips 54. FIG. 20 shows the same configuration with the addition of pick-up gear 23. Pick-up gear 23 may generally be positioned at the front or back of splined shaft 20, and idler gear 22 may be placed adjacent to pick-up gear 23 or at the opposite end of the splined shaft 20. Gears 22 and 23 may be held in place on splined shaft 20 in slots 192 by circlips 54.

Splined shaft 20 allows the use of any appropriate combination of pick-up gear 23 and idler gear 22. Idler gear 22 may be located in the center or end of splined shaft 20, based on the particular application at hand. For example, idler gear 23 may need to be relocated to provide clearance for transmission gears. Furthermore, the use of splined shaft 20 and related gears allows distributors and dealers to reduce their inventory of gears by almost 50% without sacrificing market share or available configurations.

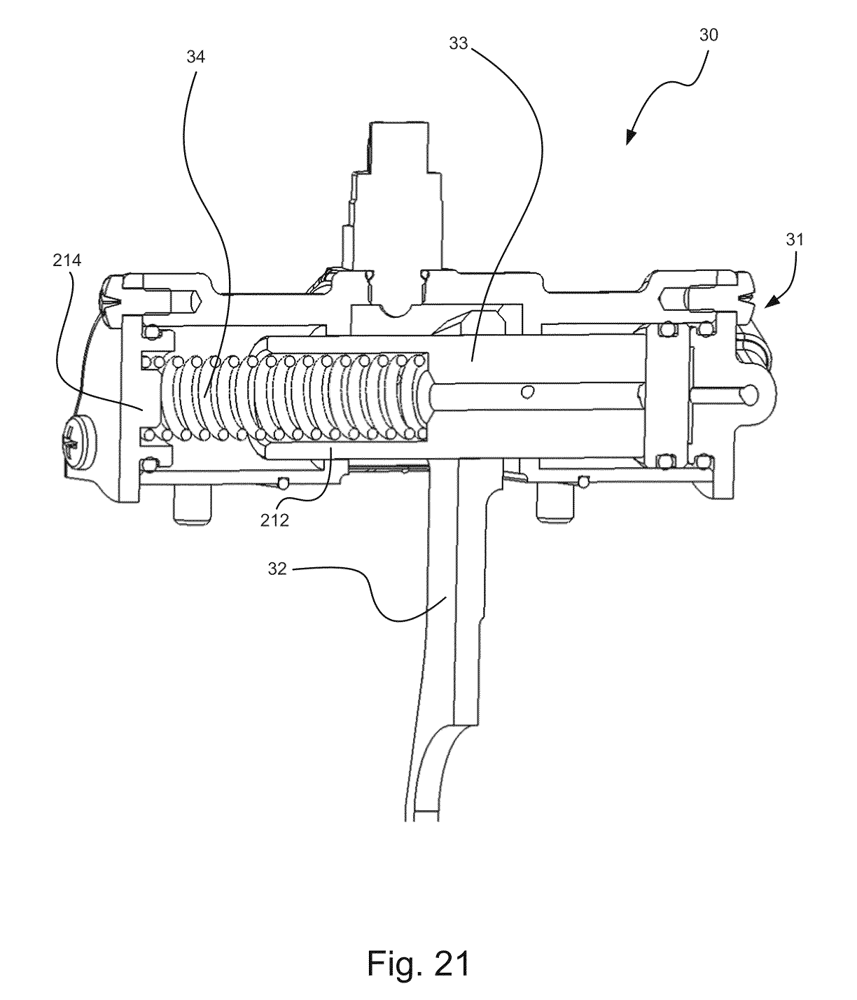

FIG. 21 shows a cutaway of an air shift unit. In particular, FIG. 21 shows a cutaway of air shift unit 30. Fork 32 may be connected to piston 33 and may move output gear 62 at its opposite end. The general operation of air shift units is well known in the art. According to the present disclosure, air shift unit 30 may incorporate a floating piston 33 that will self-align in case of any axial shift in the bore. This ability to self-align ensures smooth movement of fork 32 in spite of wear and warping of PTO 10. Spring 34 may be guided over its entire length with piston portion 212 and end portion 214, which reduces the possibility of spring 34 warping during operation.

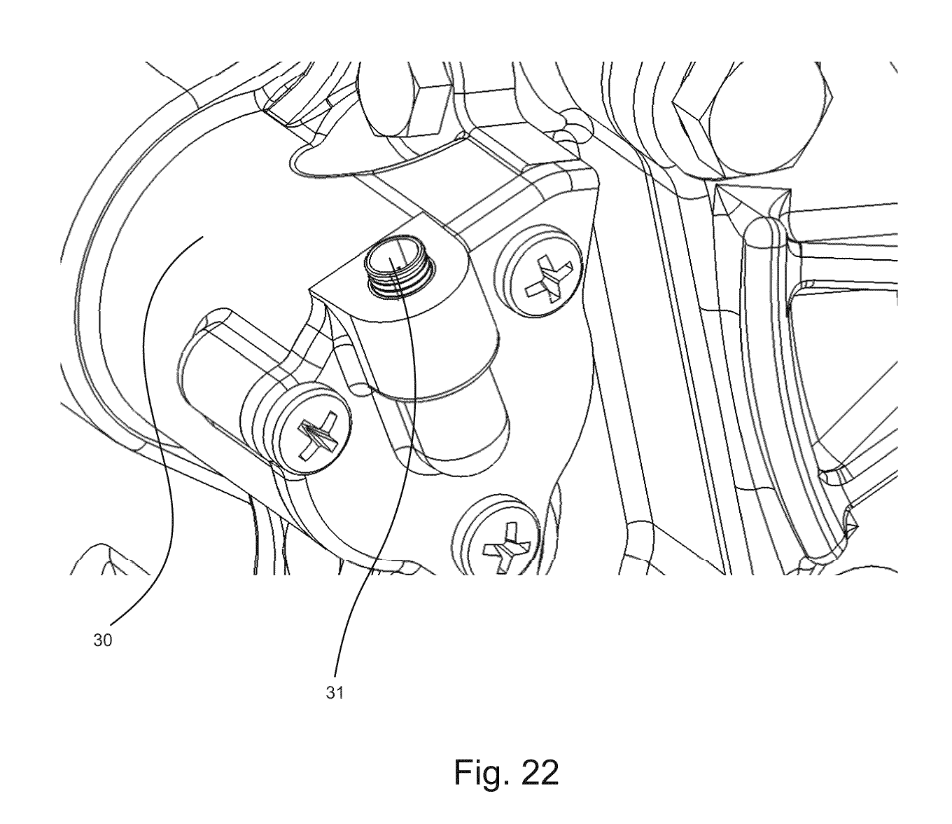

FIG. 22 shows a detail view of an air fitting. In particular, air fitting 31, shown in FIG. 22, may be a push-in type fitting, which may reduce service time and costs for replacing fitting 31. In addition, fitting 31 may be a push-pull fitting to allow it to be easily connected and disconnected from its air supply.

Accordingly, the disclosure herein describes a number of features for use in a PTO 10. Each of the features described may be used singularly to provide an enhancement over prior art PTOs. Additionally, one or more the features may be combined as described to provide numerous enhancements over prior art PTOs. Finally, the combination of all the features may be combined to provide a greatly enhanced PTO 10 with respect to prior art PTOs.

While the present disclosure has been described in terms of exemplary embodiments, those skilled in the art will recognize that the present disclosure can be practiced with modifications in the spirit and scope of the appended claims. These examples given above are merely illustrative and are not meant to be an exhaustive list of all possible designs, embodiments, applications or modifications of the present disclosure.

What is claimed is:

1. A system for transferring power from a mechanical transmission to secondary equipment, the system comprising:
a housing configured to connect to a mechanical transmission;
a splined shaft positioned within the housing;
a pick-up gear configured to transfer power from the transmission to the splined shaft, the pick-up gear further configured to be removably mounted on the splined shaft in at least two positions;
an idler gear configured to be removably mounted on the splined shaft in at least two positions;
an output gear mounted on an output shaft, the output gear configured to selectively engage the idler gear, the output gear further configured to rotate the output shaft when engaged with the idler gear;
a splined output mechanically connected to the output shaft; and
an output plate configured to removably connect to the housing, the output plate further configured to surround the splined output, the output plate still further configured to connect to secondary equipment.

2. The system of claim 1, further comprising:
an idler shaft positioned within the housing, the idler shaft structured and arranged such that the splined shaft spins about the idler shaft, the idler shaft having a first end where the shaft is connected to the housing, the idler shaft having a second end where the shaft is connected to the housing;
a first pair of O-rings positioned at the first end of the idler shaft, the first pair of O-rings configured to substantially prevent leakage of liquids inside the housing; and
a second pair of O-rings positioned at the second end of the idler shaft, the second pair of O-rings configured to substantially prevent leakage of liquids inside the housing.

3. The system of claim 1, further comprising at least one O-ring configured to substantially seal an external surface of the housing.

4. The system of claim 3, wherein the at least one O-ring comprises at least one blister configured to hold the O-ring in place during assembly or service of the system.

5. The system of claim 1, wherein the output plate comprises a monitor hole.

6. The system of claim 1, further comprising an output adaptor configured to mate with the splined output and provide a different output configuration.

7. The system of claim 1, wherein the housing comprises at least one blind mounting hole.

8. The system of claim 1, further comprising:
a grease nipple configured to provide lubricant to the splined output;
a plug configured to cover the grease nipple; and
an O-ring configured to seal the plug over the grease nipple and thereby prevent any substantial leakage of lubricant from the grease nipple.

9. The system of claim 1, further comprising:
a fork configured to mount the output gear; and
a floating piston configured to move the fork between at least a first position and a second position, wherein in the first position the output gear is engaged with the idler gear, further wherein in the second position the output gear is disengaged from the idler gear.

10. The system of claim 1, further comprising a thrust washer configured to transfer thrust from the pick-up gear to a thrust bearing.

11. The system of claim 10, wherein the thrust washer comprises at least one slot configured to promote lubrication of a bearing.

12. The system of claim 1, further comprising a push-in air fitting.

13. The system of claim 1, further comprising an additional bearing configured to align the splined output with a shaft from the secondary equipment.

14. A power take-off comprising:
a housing configured to connect to a mechanical transmission;
a splined shaft positioned within the housing;
a pick-up gear configured to transfer power from the transmission to the splined shaft, the pick-up gear further configured to removably mount on the splined shaft in at least two positions;
an idler gear configured to removably mount on the splined shaft in at least two positions;
an output gear mounted on an output shaft, the output gear configured to selectively engage the idler gear, the output gear further configured to rotate the output shaft when engaged with the idler gear;
a splined output mechanically connected to the output shaft; and
an output plate configured to removably connect to the housing, the output plate further configured to surround the splined output, the output plate still further configured to connect to secondary equipment.

15. The power take-off of claim 14, further comprising:
an idler shaft positioned within the housing, the idler shaft structured and arranged such that the splined shaft spins about the idler shaft, the idler shaft having a first end where the shaft is connected to the housing, the idler shaft having a second send where the shaft is connected to the housing;
a first pair of O-rings positioned at the first end of the idler shaft, the first pair of O-rings configured to substantially prevent leakage of liquids inside the housing; and
a second pair of O-rings positioned at the second end of the idler shaft, the second pair of O-rings configured to substantially prevent leakage of liquids inside the housing.

16. The power take-off of claim 14, further comprising at least one O-ring configured to substantially seal an external surface of the housing.

17. The power take-off of claim 16, wherein the at least one O-ring comprises at lest one blister configured to hold the O-ring in place during assembly or service of the system.

18. The power take-off of claim 14, further comprising:
a grease nipple configured to provide lubricant to the splined output;
a plug configured to cover the grease nipple; and
an O-ring configured to seal the plug over the grease nipple and thereby prevent any substantial leakage of lubricant from the grease nipple.

19. The power take-off of claim 14, further comprising an output adaptor configured to mate with the splined output and provide a different output configuration.

20. The power take-off of claim 14, further comprising an additional bearing configured to align the splined output with a shaft from the secondary equipment.
